(19) United States
(12) Patent Application Publication
(10) Pub. No.: US 2010/0022679 A1
(43) Pub. Date: Jan. 28, 2010

(54) USE OF TIMBER MATERIALS COMPRISING POLYAMINE FOR LOWERING FORMALDEHYDE CONTENT IN AMBIENT AIR

(75) Inventors: Eva Rüba, Zurich (CH); Stephan Weinkötz, Neustadt (DE); Michael Schmidt, Speyer (DE); Michael Finkenauer, Westhofen (DE); Christian Beil, Worms (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/375,234

(22) PCT Filed: Jan. 12, 2007
(86) PCT No.: PCT/EP2007/050273

§ 371 Date: Mar. 27, 2009

(30) Foreign Application Priority Data
Jul. 27, 2006 (EP) 06118012.1

(51) Int. Cl. C08L 97/02

(52) U.S. Cl. 523/103

(57) ABSTRACT

The present invention relates to the use of wood-base materials for the production of furniture parts, wall claddings, insulation materials and the like for reducing the formaldehyde content in the ambient air, the wood-base materials
(iii) comprising polyamine as a binder or
(iv) comprising a binder differing from polyamine and additionally having polyamine in or on the outer layers of the wood-base material
   and the polyamine having a molecular weight of at least 500 g/mol and at least 6 primary or secondary amino groups.

The present invention relates to the use of wood-base materials for the production of furniture parts, wall claddings, insulation materials and the like for reducing the formaldehyde content in the ambient air, the wood-base materials
(i) comprising polyamine as a binder or
(ii) comprising a binder differing from polyamine and additionally having polyamine in or on the outer layers of the wood-base material
   and the polyamine having a molecular weight of at least 500 g/mol and at least 6 primary or secondary amino groups.

Condensates based on urea, if appropriate melamine, and formaldehyde have long been used for the production of wood-base materials. They are mainly used for the production of fiber boards or particle boards for furniture construction. In addition to their advantageous price level, these resins have the advantages of easy processability and long drop times in combination with high reactivities. However, the serious disadvantage is that these wood-base materials eliminate formaldehyde during and after the processing.

Wood itself can also release formaldehyde to the environment, in particular after heat treatment. Coated wood-base materials generally have lower formaldehyde emissions than uncoated substrates (“Holz als Roh und Werkstoff”, volume 47, 1989, page 227).

Above certain limits, formaldehyde can cause allergies and irritation of the skin, respiratory tract or eyes in humans. The reduction of formaldehyde in the interior or living area is therefore an important matter.

DE 43 08 089 A1 describes a binder for gluing wood, comprising a) a polyamine, b) from 0.01 to 0.25 mol of sugar per mole of amino group of a) and c) from 0.01 to 0.25 mol of one or more components from the group consisting of dicarboxylic acid derivatives, aldehydes having two or more carbon atoms and epoxides per mole of amino group of a). For example, polyethylenimine or N,N′,N″-tris(6-aminohexyl)melamine is mentioned as the polyamine. In the examples, a formaldehyde emission of from 0.04 to 0.1 mg HCHO/m²h is described.

EP 1 192 223 B1 describes a fiber board comprising polyamines or polyamine-containing aminoplast resins as a binder. Inter alia, an aqueous solution of an aliphatic polyamine having at least three functional groups, selected from the group consisting of the primary and secondary amino groups, is mentioned as glue solution, which polyamine has a weight average molecular weight of from 600 to 1000000 g/mol and, apart from tertiary amino groups, is substantially free of other functional groups. It is stated that polyethylenimine or polyvinylamine is used as a preferred polyamine. It is disclosed that the polyethylenimine preferably has a weight average molecular weight of from 800 to 100000 and the polyvinylamine preferably has a weight average molecular weight of from 5000 to 200000.

Accordingly, the prior art contains several indications as to how said formaldehyde-containing binders can be replaced. However, there are further formaldehyde sources, such as, for example, textiles, particle boards, furniture, in particular older furniture, and cigarette smoke, in the living area.

CA 1 241 524 describes the use of polyamines as a formaldehyde scavenger. For example, filters in heating systems are coated with the polyamines or the polyamines are added as additives to wall paints.

The object of the present invention was to provide wood-base materials which can absorb formaldehyde from the ambient air, these wood-base materials already being used in the living area or expediently being capable of being integrated into the living area.

The object was achieved using wood-base materials for the production of furniture parts, wall claddings, insulation materials and the like for reducing the formaldehyde content in the ambient air, the wood-base material
(i) comprising polyamine as a binder or
(ii) comprising a binder differing from polyamine and additionally having polyamine in or on the outer layers of the wood-base material
   and the polyamine having a molecular weight of at least 500 g/mol and at least 6 primary or secondary amino groups.

Preferably used polyamines are those which have a molecular weight of at least 800 g/mol and at least 6, in particular at least 10, primary or secondary amino groups. It is possible to use only one specific polyamine or mixtures of a plurality of polyamines. Polyethylenimine or polyvinylamine or mixtures thereof are preferably chosen as polyamines.

The weight average molecular weight of the polyvinylamine is advantageously from 5,000 to 500,000 g/mol, preferably from 5,000 to 350,000 g/mol, in particular from 5,000 to 100,000. The weight average molecular weight of the polyethylenimine is advantageously from 500 to 100,000 g/mol, preferably from 500 to 70,000 g/mol, particularly preferably from 500 to 50,000 g/mol and in particular from 500 to 20,000 g/mol.

### For Use of the Polyamine as a Binder According to Case (i):

The polyamine is advantageously used in the form of aqueous solutions having a polyamine solids content of from 1 to 95% by weight, preferably from 5 to 80% by weight, as a binder. In the case of an aqueous polyvinylamine solution, the solids content is preferably from 5 to 30% by weight, in particular from 5 to 15% by weight. In the case of an aqueous polyethylenimine solution, the solids content is preferably from 10 to 60% by weight, in particular from 30 to 50% by weight.

The polyamine solution may comprise customary assistants and additives, such as water repellents, e.g. paraffins, wood preservatives or flameproofing agents.

The polyamine solution is applied by customary methods to cellulose-containing chips/fibers (cf. “MDF —Mitteldichte Faserplatten”, Hans-Joachim Deppe, Kurt Ernst, 1996, DRW-Verlag Weinbrenner GmbH & Co., 70771 Leinfelden-Echterdingen, chapter 4.3, page 81 et seq.; also see EP 1 192 223 B1, paragraph [0034]).

The polyamine solution is advantageously used as a binder in amounts such that from 0.1 to 20 g, preferably from 0.2 to 5 g, particularly preferably from 0.5 to 2.5 g, of polyamine are used per 100 g of absolutely dry fibers/chips.

The cellulose-containing chips or fibers are then pressed by a customary method to give wood-base materials. For this purpose, a chip or fiber mat is produced by sprinkling the cellulose-containing chips or fibers onto a support and said mat is then pressed at temperatures of from 80 to 250° C. and at pressures of from 5 to 50 bar to give wood-base materials (cf. loc. cit. chapter 4.5, page 93 et seq.).

The cellulose-containing fibers are preferably sprinkled on to give wood-base materials having a layer thickness such that, after the hot pressing, wood-base materials having a density of from 100 to 1000 kg/m³, preferably from 450 to 900 kg/m³, and a thickness of from 0.5 to 200 mm, preferably from 1 to 40 mm, particularly preferably from 1.5 to 20 mm, result.

### For Use of the Polyamine in a Protective Layer for a Wood-Base Material According to Case (ii):

The polyamines or the aqueous polymer solution can be applied to the glued wood-base material. All binders known to a person skilled in the art can be used as binders for producing the wood-base material, in particular aminoplast resins.

The aqueous polymer solution is obtainable in particular by mixing—in each case based on the polymer solution —
(a) from 1 to 99% by weight of polyamine
(b) from 0 to 5% by weight of additives for improving the wettability
(c) from 0 to 30% by weight of additives for adjusting the pH
(d) from 0 to 30% by weight of other additives, such as fungicides, water repellents, dyes, organic solvents
(e) from 0 to 20% by weight of urea
   and water to make up to 100% by weight, these data being based on the beginning of mixing.

The aqueous polyamine solution advantageously comprises from 5 to 90% by weight of polyamine, preferably from 10 to 75% by weight of polyamine, in particular from 15 to 45% by weight of polyamine, particularly preferably from 25 to 40% by weight polyamine, based in each case on the polymer solution.

As optional component (b) of the aqueous polymer solution, it is possible to use ionic and nonionic surfactants, as described, for example, in H. Stache, “Tensid-Taschenbuch”, Carl Hanser Verlag, Munich, Vienna, 1981, in a concentration of, advantageously, from 0 to 5% by weight, preferably from 0 to 2% by weight, for improving the wettability.

The pH can be adjusted by the following additives as optional component (c): mineral or organic acids, such as, for example, sulfuric acid or formic acid. Component (c) can be added to the aqueous polymer solution in an amount of from 0 to 30% by weight, preferably from 0 to 20% by weight.

As optional component (d), it is possible to add further additives to the aqueous polymer solution, for example additives from the group consisting of water repellents, e.g. paraffin emulsions and waxes, fungicides, organic solvents or dyes. Component (d) can be added to the aqueous polymer solution in an amount of from 0 to 30% by weight, preferably from 0 to 10% by weight.

As optional component (e), the aqueous polyamine solution may comprise up to 20% by weight of urea, based on the polymer solution. The aqueous polymer solution advantageously comprises less than 15% by weight of urea, preferably less than 10% by weight of urea and in particular less than 5% by weight of urea, based in each case on the polymer solution. Particularly preferably, the polymer solution is free of urea.

The polyamine solution is advantageously applied with a pH of from 3 to 12, preferably from 6 to 11, in particular with a pH of from 9 to 11.

A sufficient amount of polyamine solution is applied so that the amount of polyamine per m² of surface area of the wood-base material is from 0.1 g to 100 g, preferably from 0.5 g to 50 g, particularly preferably from 1 g to 10 g.

The aqueous polymer solution can be applied to the wood-base material by various measures known to the person skilled in the art. These include, for example, spraying on, roll-coating, immersion, knife coating, brushing or curtain coating. The amine solution is preferably applied by spraying on and roll-coating in particular by roll-coating.

The wood-base materials obtained by the method (i) or (ii) can be further processed as usual and are suitable in particular for the production of furniture parts, wall claddings, insulation materials and the like, i.e. articles/objects comprising wood which are in direct contact with room air or with a formaldehyde source. Preferably, the wood-base materials thus produced are used for the production of furniture rear panels.

Preferably, the wood-base materials are obtained by the method (i) and are thus formaldehyde-free.

The furniture parts, wall claddings, insulation materials and the like which are produced in this manner are not only themselves formaldehyde-free or low-formaldehyde articles, but these articles can also absorb formaldehyde from the ambient air and thus permanently reduce the formaldehyde pollution in, for example, living rooms.

### EXAMPLES

### Example 1

An MDF board A (30×30 cm) which had a density of 850 kg/m³ and a thickness of 4 mm was produced using a binder consisting of a 30% by weight aqueous polyethylenimine solution (weight average molecular weight of the polyethylenimine: 5000 g/mol), the binder having been used in an amount of 1.5 g of solid per 100 g of absolutely dry fibers. The pressing was carried out at a pressure of 4 N/mm² and a pressing temperature of 200° C. and in a pressing time of 120 s.

The thickness and density of the MDF board were chosen according to the usual form for the production of, for example, furniture rear panels.

### Example 2

An MDF board B (30×30 cm) which had a density of 850 kg/m³ and a thickness of 4 mm was produced using a binder consisting of a 30% by weight aqueous polyethylenimine solution (weight average molecular weight of the polyethylenimine: 5000 g/mol), the binder having been used in an amount of 3 g of solid per 100 g of absolutely dry fibers. The pressing was carried out analogously to Example 1.

### Example 3

An MDF board C (30×30 cm) which had a density of 850 kg/m³ and a thickness of 4 mm was produced using a urea-formaldehyde condensation resin (Kaurit glue 340, 68% solid resin content), the binder having been used in an amount of 12 g of solid resin per 100 g of absolutely dry fibers. The pressing was carried out analogously to Example 1. Thereafter, the board was sprayed on the top and bottom with 10 g/m² of a 30% strength by weight polyethylenimine solution (weight average molecular weight of the polyethylenimine: 1300 g/mol) (active substance: 3 g/m²) and dried for 24 h at room temperature.

### Example 4

An MDF board D (30×30 cm) which had a density of 850 kg/m³ and a thickness of 4 mm was produced without using a binder, the moist fiber cake (20% moisture) having been pressed to give a loose board at a pressure of 4 N/mm², and a pressing temperature of 200° C. and in a pressing time of 200 s.

### Example 5

### Commercially Available Particle Board as a Formaldehyde Source

This is a commercially available particle board E which had a density of 670 kg/m³ and a thickness of 16 mm and a formaldehyde emission of 1.16 mg/l (desiccator method). The thickness and density of the particle board were chosen according to the usual form for furniture production.

### Measurement of the Formaldehyde Emission:

The formaldehyde emission was determined by means of the desiccator method (JIS A 5908). Each desiccator measurement was effected using 10 test specimens. Either 10 test specimens of a board type (boards A to D) were measured or 5 test specimens (board E) and 5 test specimens (board A or B or C or D) were measured. The desiccator values are listed in Table 1.

TABLE 1
Overview of the desiccator values

| Test specimen | Desiccator value [mg/l] |
|---|---|
| MDF board A | <0.01 |
| MDF board B | <0.01 |
| MDF board C | 0.03 |
| MDF board D | 0.12 |
| Particle board E | 1.16 |
| Particle board E + MDF board A | 0.29 |
| Particle board E + MDF board B | 0.21 |
| Particle board E + MDF board C | 0.25 |
| Particle board E + MDF board D | 0.80 |

The examples show that the formaldehyde which was released to the ambient air by particle board E was scavenged by the use of an MDF board A, B or C, and the formaldehyde content of the room air could thus be effectively reduced.

1-6. (canceled)

7. A method for making a wood material for the production of furniture parts, wall claddings, insulation materials and the like for reducing the formaldehyde content in ambient air, the method comprising:
applying to cellulose-containing chips or fibers a composition comprising
(i) polyamine as a binder or
(ii) a binder differing from polyamine and additionally having polyamine in or on the outer layers of the wood material,
and the polyamine having a molecular weight of at least 500 g/mol and at least 6 primary or secondary amino groups; and
pressing the cellulose-containing chips or fibers to form a wood material.

8. The method according to claim 7, the polyamine having a molecular weight of at least 800 g/mol and at least 10 primary or secondary amino groups.

9. The method according to claim 7, wherein the polyamine is polyvinylamine and/or polyethylenimine.

10. The method according to claim 9, the polyvinylamine having a weight average molecular weight of from 5,000 to 500,000 g/mol and the polyethylenimine having a weight average molecular weight of from 500 to 100,000 g/mol.

11. The method according to claim 9, the polyvinylamine having a weight average molecular weight of from 5,000 to 100,000 g/mol and the polyethylenimine having a weight average molecular weight of from 500 to 20,000 g/mol.

12. The method according to claim 7, wherein the polyamine is in the form of an aqueous solution having a solids content from 1 to 95% by weight.

13. The method according to claim 9, wherein the polyvinylamine is in the form of an aqueous solution having a solids content from 5 to 30% by weight.

14. The method according to claim 9, wherein the polyethylenimine is in the form of an aqueous solution having a solids content from 10 to 60% by weight.

15. A wood material for the production of furniture parts, wall claddings, insulation materials and the like for reducing the formaldehyde content in ambient air, obtained by the method according to claim 7.

16. A furniture rear panel obtained by the method according to claim 7.

17. A method for making a wood material for the production of furniture parts, wall claddings, insulation materials and the like for reducing the formaldehyde content in ambient air, the method comprising:
applying to a wood material a protective layer comprising
(i) polyamine as a binder or
(ii) a binder differing from polyamine and additionally having polyamine in or on the outer layers of the wood material,
and the polyamine having a molecular weight of at least 500 g/mol and at least 6 primary or secondary amino groups.

18. The method according to claim 17, wherein the wood material comprises cellulose-containing chips or fibers.

19. A wood material for the production of furniture parts, wall claddings, insulation materials and the like for reducing the formaldehyde content in ambient air, the wood material comprising:
(i) polyamine as a binder or
(ii) a binder differing from polyamine and additionally having polyamine in or on the outer layers of the wood material,
and the polyamine having a molecular weight of at least 500 g/mol and at least 6 primary or secondary amino groups; and
(iii) cellulose-containing chips or fibers.

20. The wood material according to claim 19, the polyamine having a molecular weight of at least 800 g/mol and at least 10 primary or secondary amino groups.

21. The wood material according to claim 19, wherein the polyamine is polyvinylamine and/or polyethylenimine.

22. The wood material according to claim 21, the polyvinylamine having a weight average molecular weight of from 5,000 to 500,000 g/mol and the polyethylenimine having a weight average molecular weight of from 500 to 100,000 g/mol.

23. The wood material according to claim 21, the polyvinylamine having a weight average molecular weight of from 5,000 to 100,000 g/mol and the polyethylenimine having a weight average molecular weight of from 500 to 20,000 g/mol.

24. The wood material according to claim 19, wherein the polyamine is in the form of an aqueous solution having a solids content from 1 to 95% by weight.

25. The wood material according to claim 21, wherein the polyvinylamine is in the form of an aqueous solution having a solids content from 5 to 30% by weight.

26. The wood material according to claim 21, wherein the polyethylenimine is in the form of an aqueous solution having a solids content from 10 to 60% by weight.
